(19) United States
(12) Patent Application Publication
(10) Pub. No.: US 2017/0238761 A1
(43) Pub. Date: Aug. 24, 2017

(54) Forced Air Grill

(71) Applicant: Steven Carl Jungmeyer, Jefferson City, MO (US)

(72) Inventor: Steven Carl Jungmeyer, Jefferson City, MO (US)

(21) Appl. No.: 15/049,175

(22) Filed: Feb. 22, 2016

(51) Int. Cl. A47J 37/07

(52) U.S. Cl. CPC A47J 37/0754

(57) ABSTRACT

This grills temperature is controlled by the use of thermocouple to turn a fan on and off which supplies air to the fuel. The thermocouple signal is sent to a chip, which amplifies the signal. The signal is sent to another chip, which compares thermocouple voltage to a voltage supplied from a voltage divider circuit. When the set point of the voltage divider circuit is above the thermocouple voltage, the fan will turn on supplying air to the fuel, which will increase the temperature. When the voltage of the thermocouple reaches the set point voltage of the voltage divider circuit, the fan will turn off. The fan can also be operated by a timer circuit to turn the fan on and off at different time intervals. A switch on the control panel lets you select which method you want to use. The design of the grill makes it easy to add charcoal and clean out ashes. The removable tray gives you an option to prevent flare-ups so you don't have to constantly monitor the grill. This grill can be used for either grilling or smoking meat.

### BACKGROUND OF THE INVENTION

This grill utilizes a fan to force air through an air duct and into the lower chamber of the firebox, up through the charcoal or other source of fuel. The formed wire charcoal baskets are supplied with blanks to block off airflow when the charcoal baskets are not in use. The smoke and heat then rise through the exhaust ports in the side and upper chamber of the grill and out the exhaust stack.

Using a thermocouple to monitor the temperature of the cooking surface, you can control the air supplying the fuel by turning the fan on and off. A thermocouple produces a voltage in milli-volts proportional to temperature. A chip amplifies the thermocouple voltage. The knob on the control panel is part of the voltage divider circuit to adjust the set point. By using a comparator circuit to compare voltage of the amplified thermocouple voltage to that of the voltage divider circuit, you can turn the fan off and on to control heat.

By cooking with the top pan installed you eliminate flare-ups and you don't have to be at the grill constantly to monitor the meat. You can also cook with the top pan removed or a combination of the two.

With the fan supplying air to the charcoal, it also makes starting the charcoal going much easy.

### BRIEF SUMMARY of the INVENTION

The forced air grill can be used for cooking, grilling or smoking meat. By monitoring the temperature with a circuit designed using a thermocouple, you can control the supply of air to the fuel, which in turn controls the temperature.

### BRIEF DESCRIPTION OF DRAWINGS

Drawings 1 thru 16 shows various views and configurations for the design of the grill.

Drawings 17 thru 19 represent the schematic diagram on control circuitry.

Drawings 20 and 21 are bill of material and contact developments used in build the control circuit.

### DETAILED DESCRIPTION OF THE INVENTION

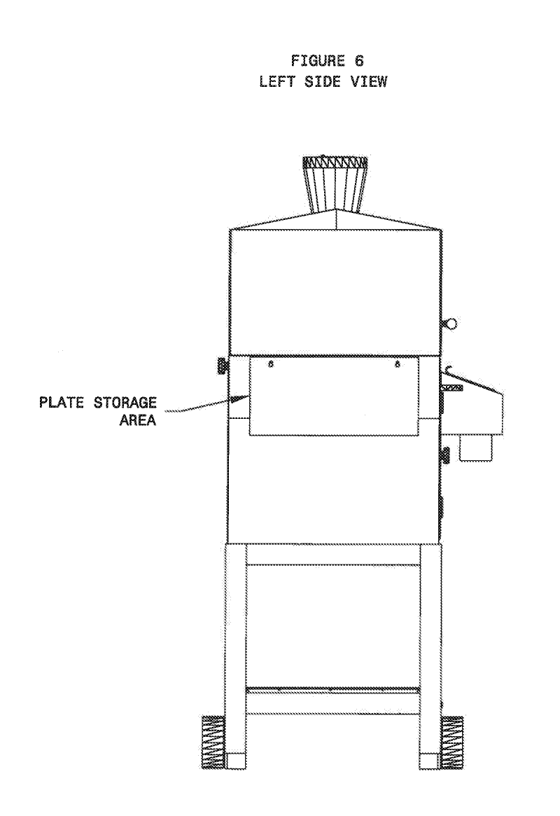

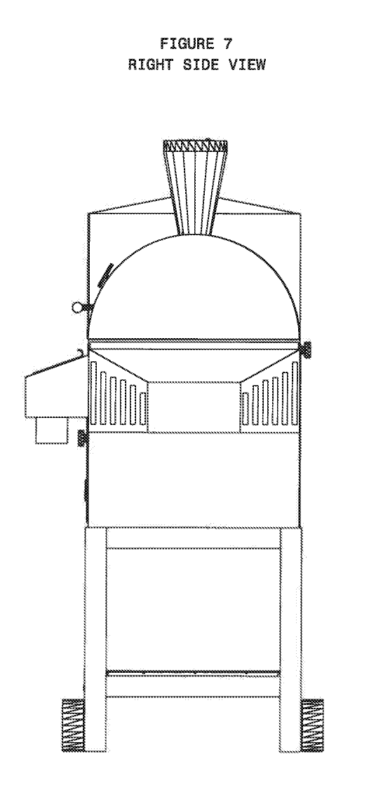

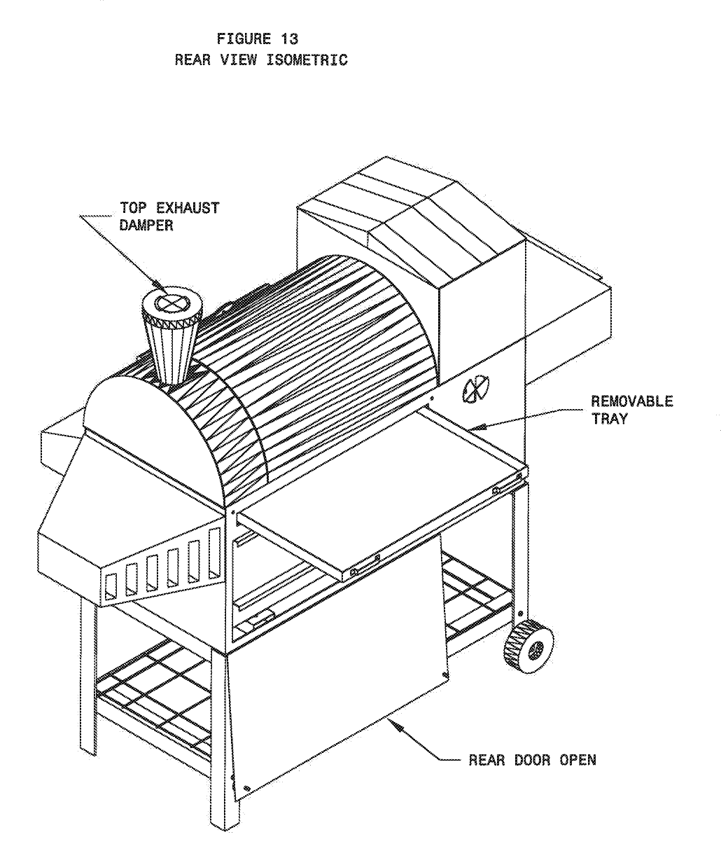

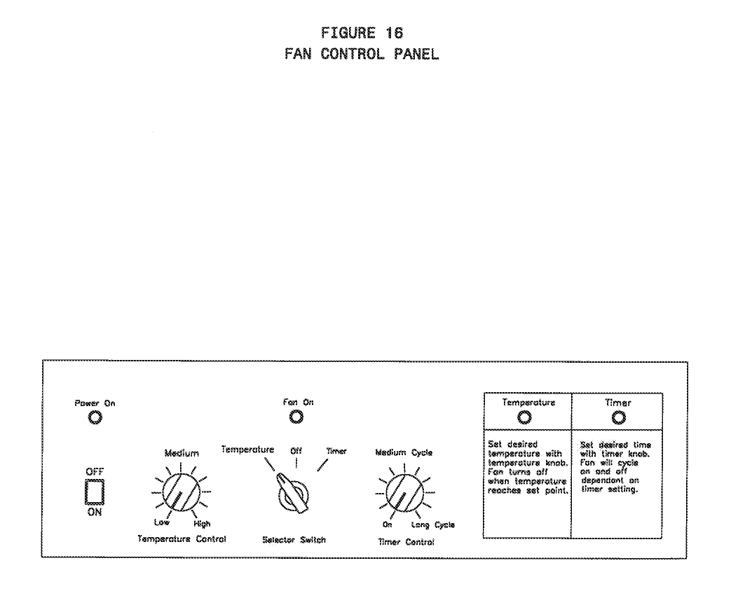

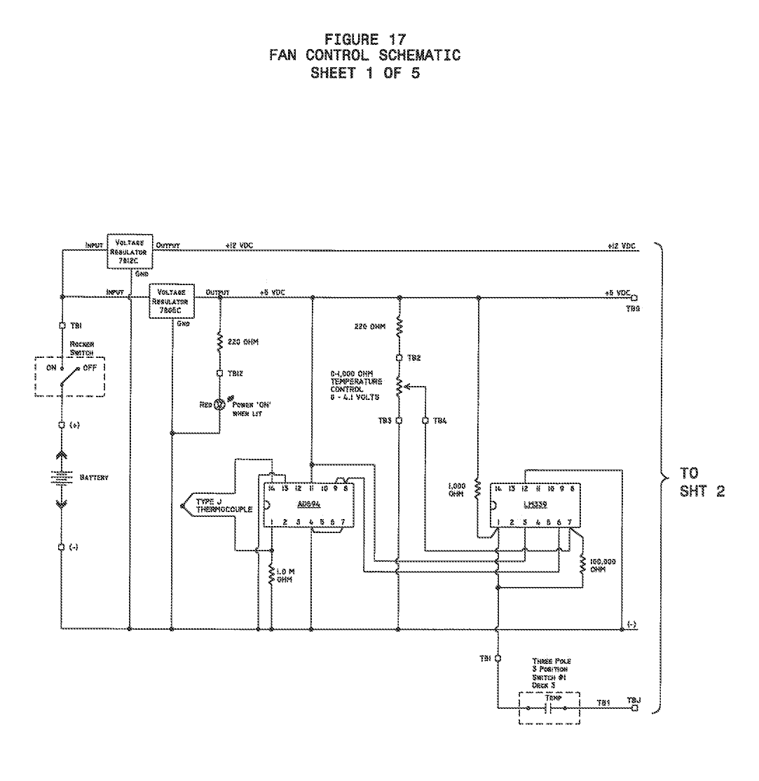

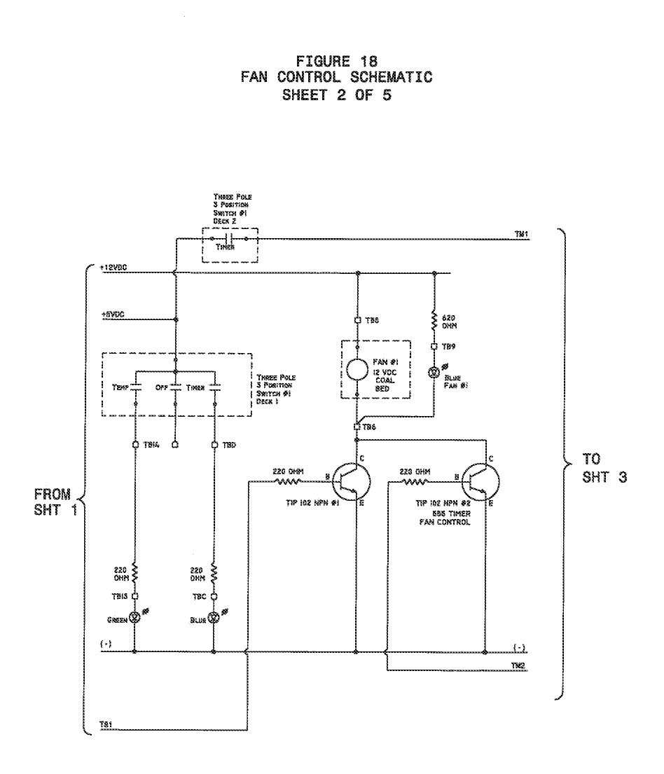

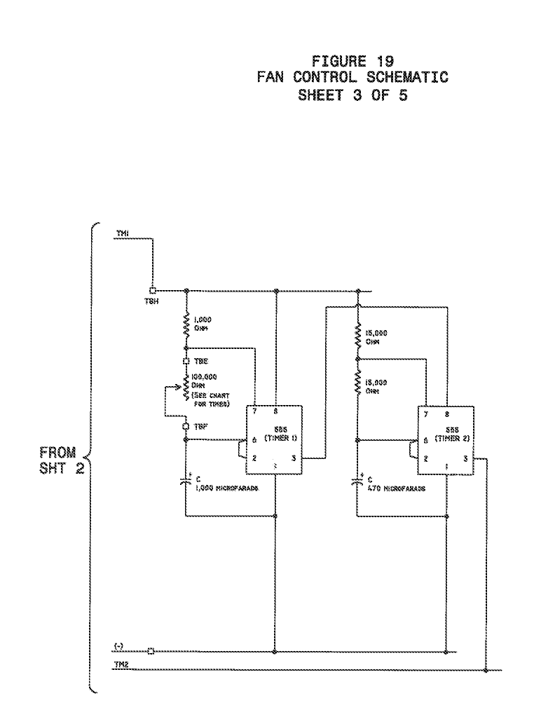

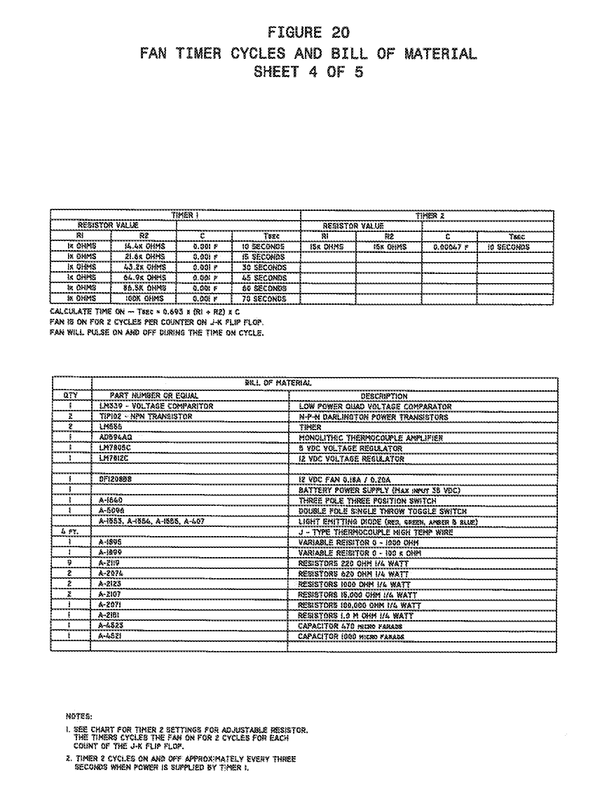

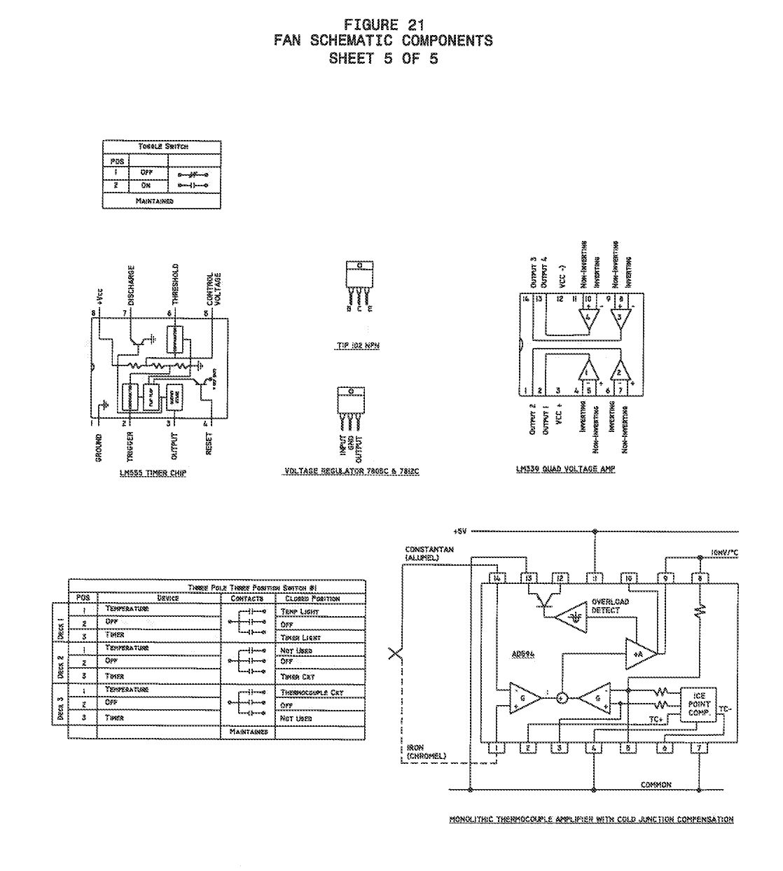

This grill uses a DC fan to force air through the grill, instead of a natural draft. A thermocouple, which creates a voltage proportional to temperature, is used to monitor temperature of the grill at the cooking surface. Using a voltage divider circuit (temperature control know on the control panel, reference FIG. 16, sheet 16 of 21) for the set point, you can control when the fan turns on and off which supplies air to the fuel. You can also operate the fan by the use of a timer. You can adjust the timer to turn the fan on and off at different intervals. The grill is designed with a removable tray (reference FIGS. 10 and 13, sheet 10 and 13 of 21). With the tray installed, your exhaust exits out the left side of the grill, over the cooking area and out top exhaust. If you don't want to cook with the tray installed, the exhaust will exit through the cooking area and out top exhaust. With the tray installed, you don't have to worry about flare-ups

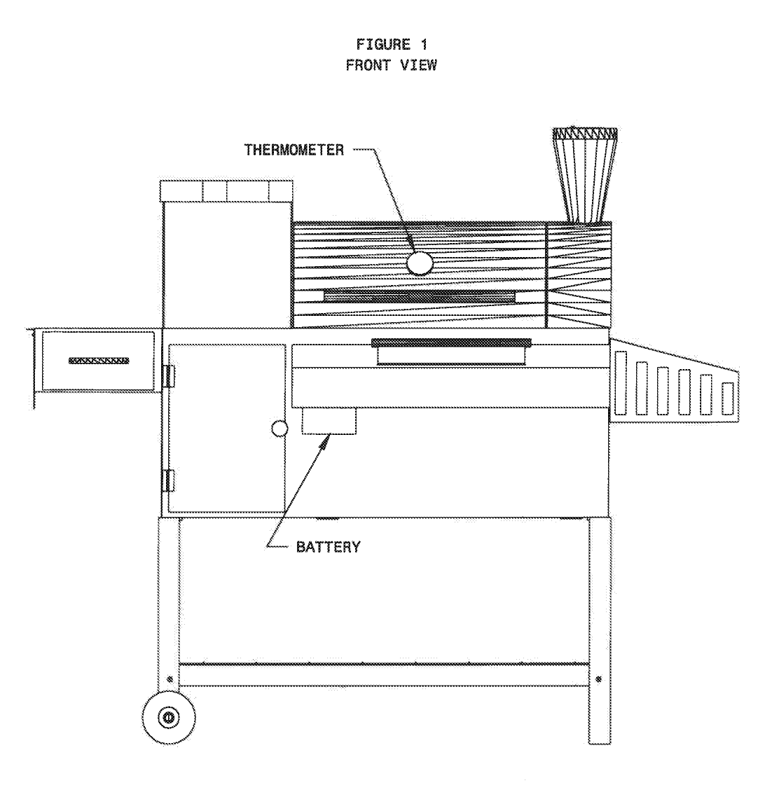

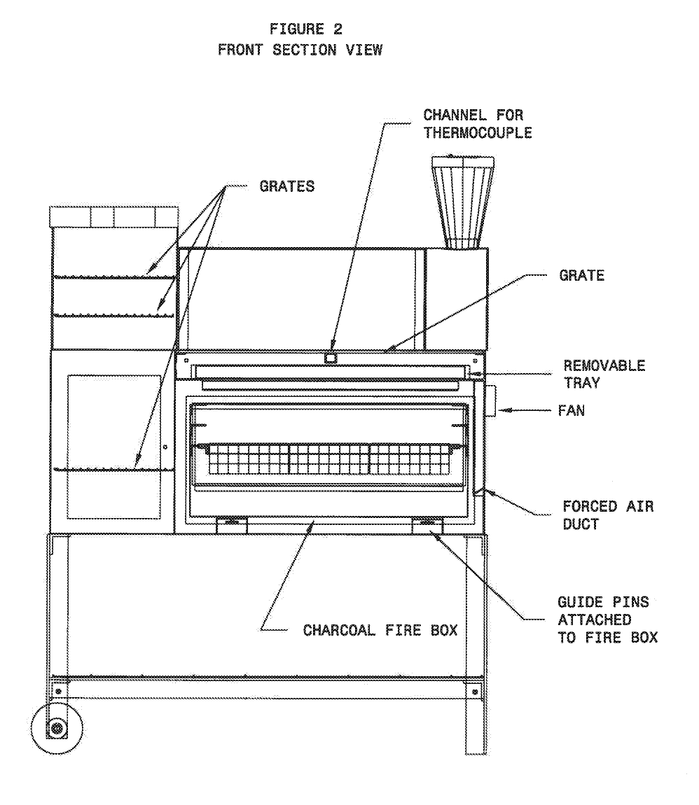

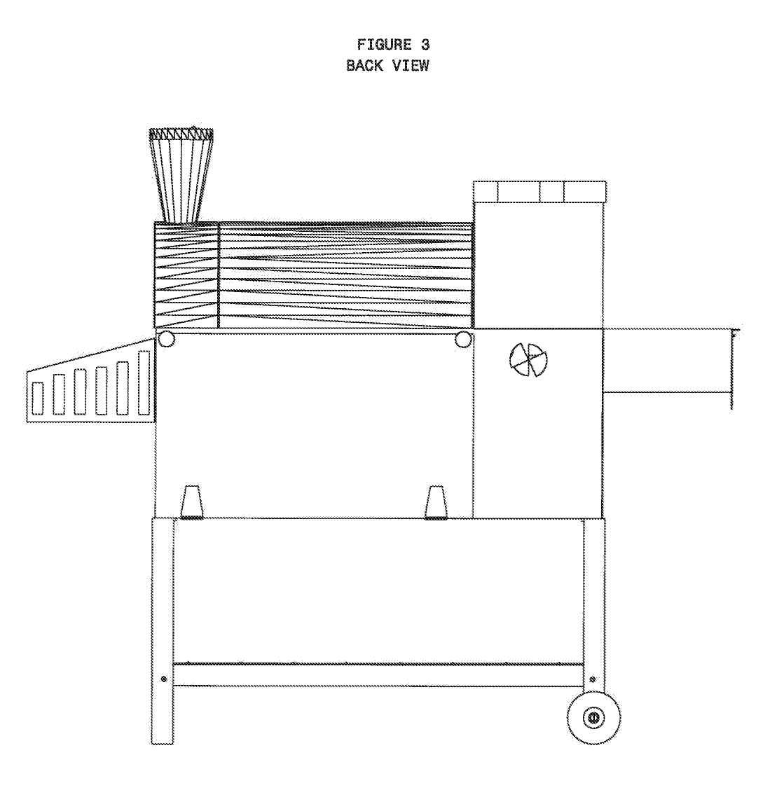

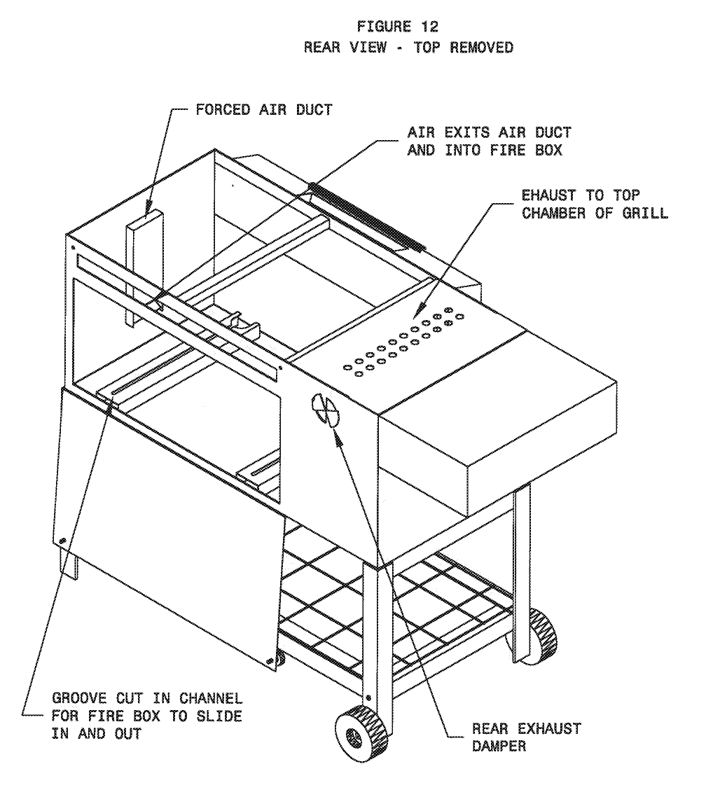

1. This charcoal grill is a unique ornamental design in the form of a train and can be used in multiple ways. Air is supplied to grill by use of a DC fan. A circuit using a thermocouple to monitor temperature controls the fan. The fan directs airflow into lower portion of charcoal firebox. Air filters up through charcoal wire baskets and into exhaust holes in upper chamber of charcoal grill. This makes starting charcoal easy and convenient. A removable tray is located above the charcoal firebox. You can use this grill with the tray either installed or removed or a combination of the two. (Reference FIGS. 2, 12, 14 and 15)

2. A thermocouple, used in conjunction with control circuitry, is used to control temperature by turning a fan off and on supplying air to the charcoal. Thermocouples produce a voltage in with regard to temperature. Thermocouple voltage rises when temperature increases and voltage decreases when temperature decreases. Using a voltage divider circuit for the set point, (temperature knob on control panel) you can control the air supply by turning the fan off and on when thermocouple voltage is above or below set point to achieve the desired cooking temperature. The fan can also be operated by a timing circuit to pulse the fan on and off at different time intervals. (Reference FIGS. 16 thru 21) This claim also applies to other charcoal grills used for outdoor cooking.

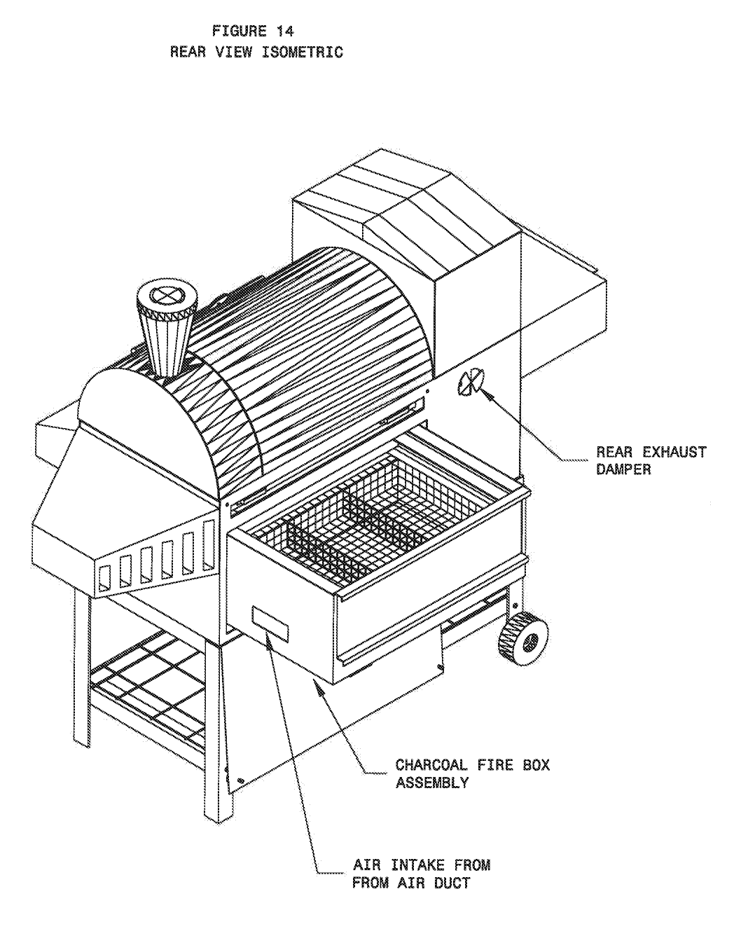

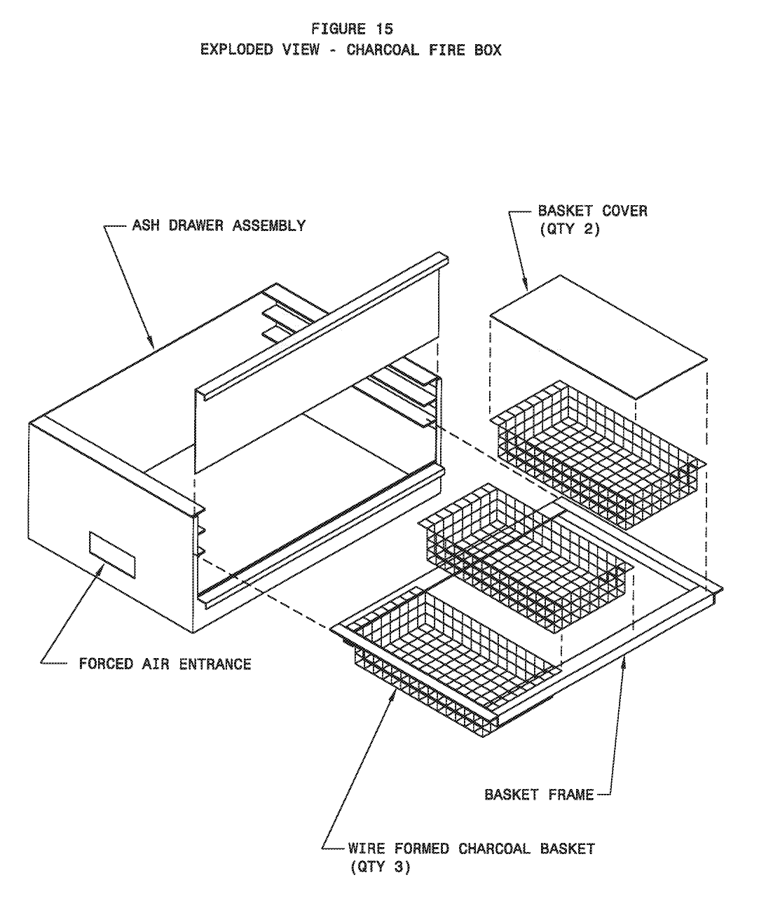

3. Design of charcoal firebox referenced in claim 1. The charcoal firebox is accessed from rear of grill by opening rear door of the grill. The charcoal firebox is designed to funnel air up through the charcoal, like a chimney. The charcoal firebox can pull out to a certain point for ease of adding charcoal, adjusting height of the charcoal wire baskets and cleaning ashes. (Reference FIGS. 14 and 15)

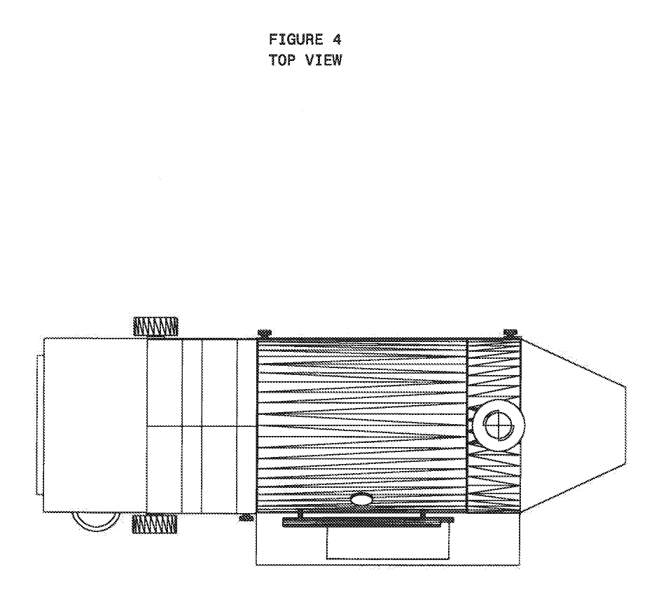

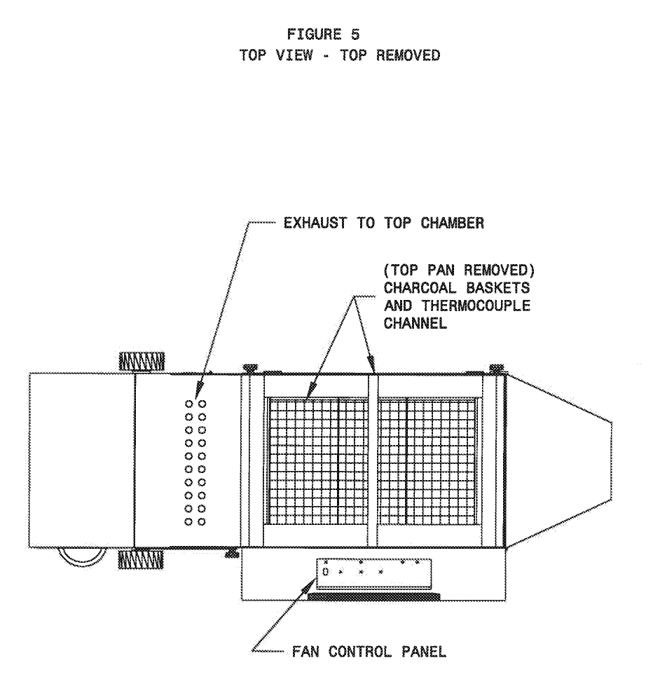

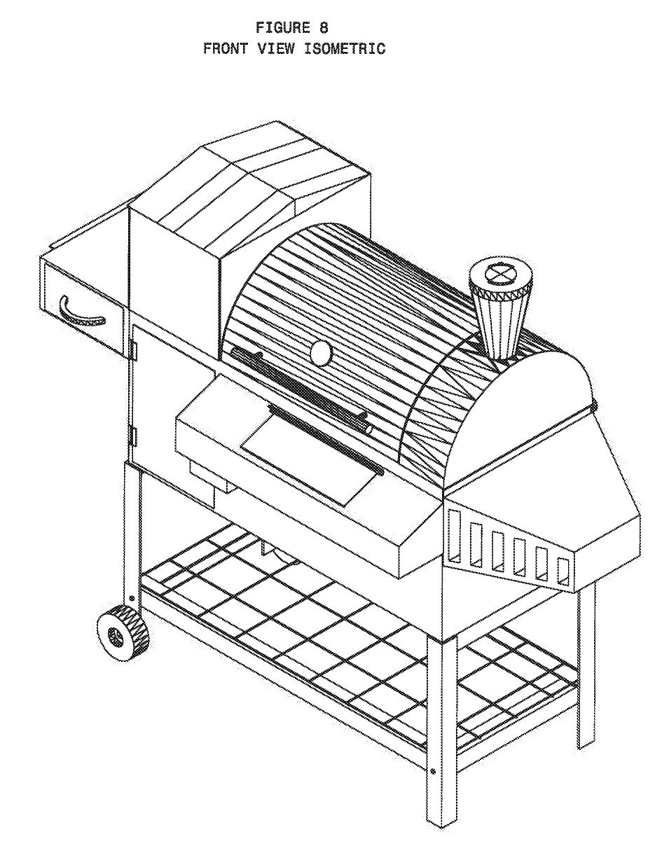

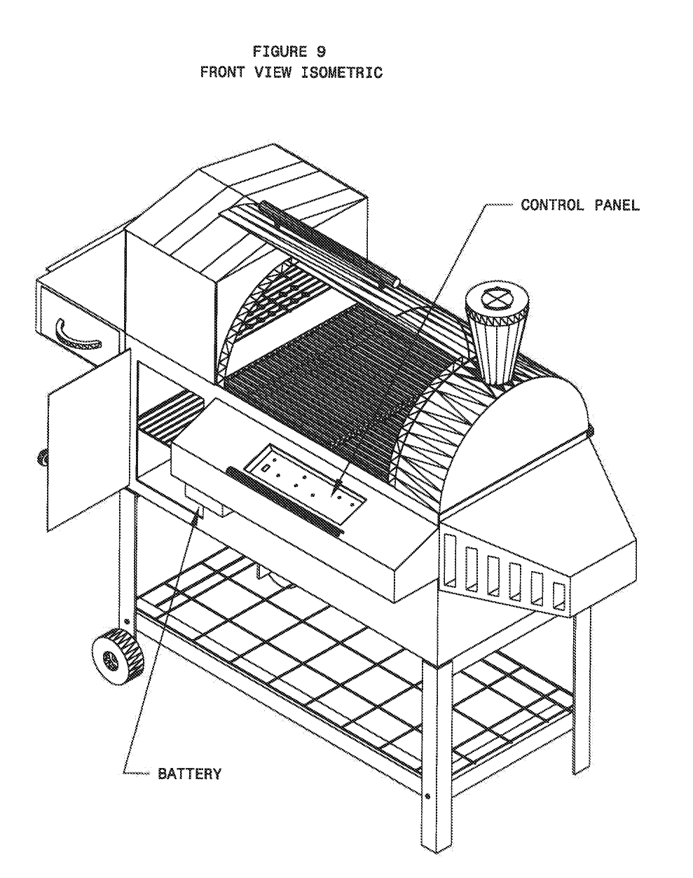

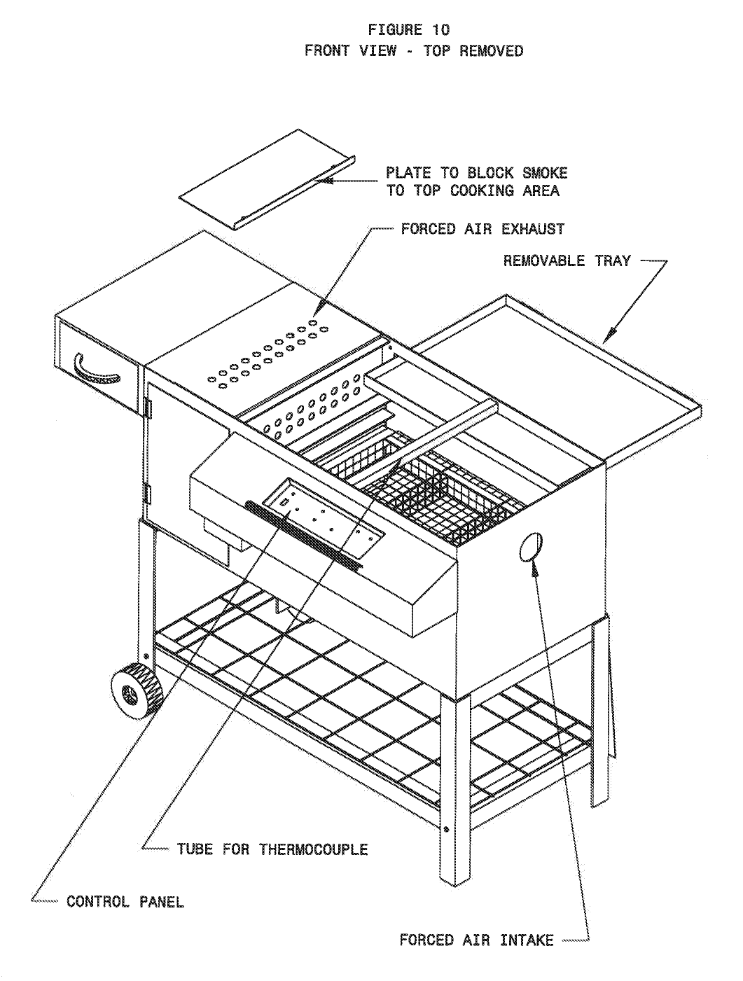

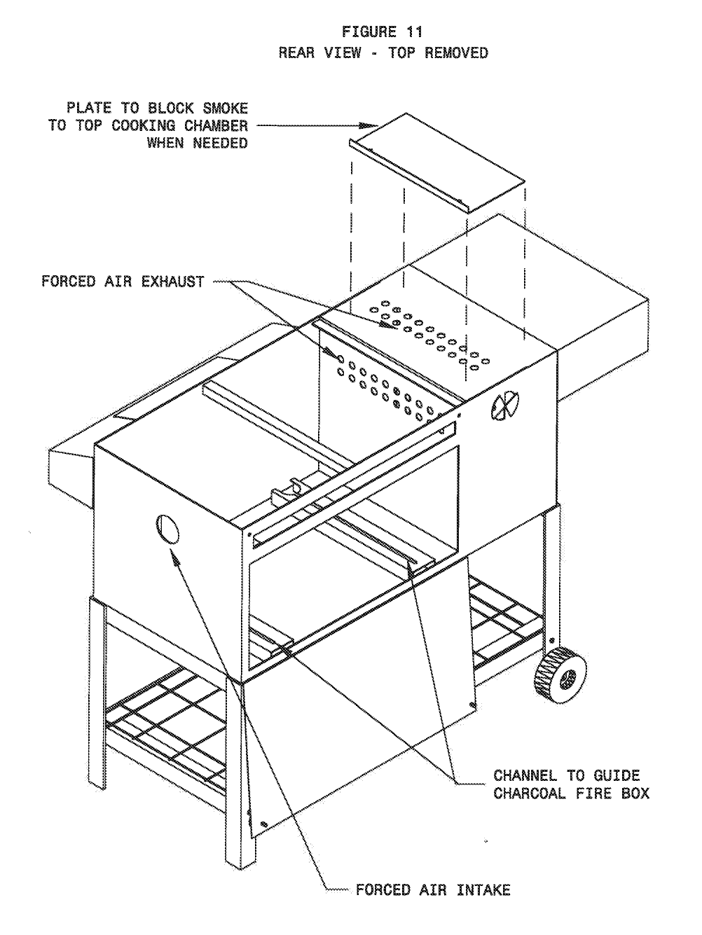

4. Design of charcoal wire baskets and covers. The basket is formed out of wire to create a mesh basket, which holds the charcoal. The use of individual wire mesh charcoal baskets makes it easier when only using a portion of the grills cooking surface. When other baskets are not in use, the grill is supplied with plates to block off airflow to charcoal baskets to ensure airflow is going through charcoal in use. Ease of access to charcoal firebox makes it easy to add additional charcoal for long cooking times. (Reference FIGS. 3, 11, 12, 14 and 15) This claim also applies to other charcoal grills used for outdoor cooking.

5. The removable tray above the charcoal firebox as referenced in claim 1. The grill can be used with tray above the charcoal firebox either installed or removed, or a combination of the two. The removable tray above charcoal firebox, when inserted, seals the charcoal fire box from the cooking surface, diverting air to exhaust on side of grill, out over cooking surface and out top exhaust stack. The advantage of grilling with tray in is you don't have to worry about flare-ups. A grate located above the exhaust on side of grill in top chamber could be used for smoking meat or as a warmer. With the top tray removed, you can use the plate to block off the exhaust on the side of the grill and cook in the traditional way. (Reference FIGS. 2, 10 and 13)

6. Staring charcoal is easy as referenced in claim 1. Open rear door of grill to access charcoal firebox, pull out charcoal firebox and adjust height of wire basket assembly which will hold the charcoal. Add charcoal to wire baskets. If any baskets are not used, they can be blocked off by supplied plates. Insert firebox, remove removable tray, add lighter fluid onto charcoal, light charcoal and turn on fan. You can then either reinstall removable tray or leave it removed and close the rear door. Your charcoal will be ready for cooking in no time.
